(19) United States
(12) Patent Application Publication
(10) Pub. No.: US 2017/0201583 A1
(43) Pub. Date: Jul. 13, 2017

(54) METHOD FOR SETTING UP A SENSOR SYSTEM

(71) Applicant: MODCAM AB, Lund (SE)

(72) Inventors: Marcus Leyman, Malmö (SE); Karl-Anders Johansson, Limhamn (SE); Tord Wingren, Malmö (SE); Bogdan Tudosoiu, Hjärup (SE); Jan Erik Solem, Bjärred (SE)

(73) Assignee: MODCAM AB, Lund (SE)

(21) Appl. No.: 15/313,864

(22) PCT Filed: May 25, 2015
(86) PCT No.: PCT/SE2015/050599

§ 371 Date: Nov. 23, 2016

(30) Foreign Application Priority Data
May 27, 2014 (SE) 1450636-4
Feb. 25, 2015 (SE) 1550212-3

(51) Int. Cl. H04L 29/08; H04W 12/08; G06K 19/06; H04L 29/06; G06K 7/14; H04W 12/04; H04L 12/24

(52) U.S. Cl. CPC H04L 67/12; H04W 12/04; H04W 12/08; H04L 41/0803; H04L 63/0428; H04L 63/061; G06K 7/1417; G06K 19/06028

(57) ABSTRACT

A method is disclosed for setting up a sensor system (100), comprising an optical image sensor (102), a processing unit (110) and a communication unit (114). The method comprises: preventing the communication unit (114) from communicating with an external unit before set-up of the sensor system (100); acquiring (304) an image by means of the optical image sensor (102), said image comprising information which is machine-readable and which comprises set-up instructions; extracting (308) said information from the acquired image by means of the processing unit (110); identifying (314) that the extracted information corresponds to set-up instructions;triggering (406) the communication unit (114) to identify an external unit (120) in a computer network; and establishing a secure communication channel between the communication unit (114) and said external unit (120) using the set-up instructions

### TECHNICAL FIELD

The present invention relates to a method for setting up a sensor system which comprises an optical image sensor, and to a device for acquiring information relating to a surrounding to the device comprising an optical image sensor.

### BACKGROUND OF THE INVENTION

Digital cameras have substantially decreased in size and price over the last years. This has implied that the use of digital cameras is becoming increasingly popular for a number of applications.

Further, it has also become possible to transmit information with high speed within wireless networks. Hence, it is possible to send videos, even in live stream, over wireless networks. This has further increased interest in using digital cameras and connecting digital cameras to a network, wherein information is at least partly to be wirelessly transmitted.

The use of digital cameras is therefore becoming widely used in a number of applications, such as applications providing surveillance for deterring intruders from entering a private home or business facilities, applications providing monitoring of an area of interest, e.g. for providing statistics of number of people entering a building, and applications for controlling an object, e.g. providing input for opening a door when a person approaches a doorway.

There may be several reasons for a desire to arrange the digital camera to communicate with a remote unit through wireless communication. Wireless communication implies that there may be no need to attach the digital camera by cable to a network. This implies that installation of the digital camera may be substantially simplified, and the cable will not affect the general appearance of a room or environment in which the digital camera is installed, such as a private home. Further, a user may want to control the digital camera through a portable device, such as a mobile phone, and wireless communication to and from the digital camera would facilitate such control.

However, the digital cameras may be arranged to acquire sensitive information. Therefore, a party setting up the digital camera may want to ensure that acquired images or videos are protected from being accessed by others. The digital camera may be arranged to exchange encrypted information, which implies that even if a third party may pick up a wireless signal from the digital camera, access to the decrypted information may be prevented.

Once a secure communication is set up between two communicating units, it may be quite safely considered to prevent third parties to access decrypted information. However, it is desired that the communication between the digital camera and a remote unit is easily set up, so as to allow a user having limited experience in installing electronic devices to set up the communication. Further, the communication should be set up in a secure manner, such that a third party may not be able to manipulate or crack into the communication system.

### SUMMARY OF THE INVENTION

It is an object of the invention to enable a simple and secure method for setting up a sensor system, which comprises an optical image sensor. It is a further object of the invention to provide a device comprising an optical image sensor, wherein the device may be controlled in a secure manner.

These and other objects of the invention are at least partly met by the invention as defined in the independent claims. Preferred embodiments are set out in the dependent claims.

According to a first aspect of the invention, there is provided a method for setting up a sensor system, comprising an optical image sensor, a processing unit and a communication unit, said sensor system before set-up only being able to receive information via said optical image sensor, said method comprising: acquiring an image by means of the optical image sensor, said image comprising information which is machine-readable and which comprises set-up instructions; extracting said information from the acquired image by means of the processing unit; identifying that the extracted information corresponds to set-up instructions; triggering the communication unit to identify an external unit in a computer network; establishing a secure communication channel between the communication unit and said external unit using the set-up instructions extracted from the acquired image.

Thanks to the first aspect of the invention, the sensor system will not receive or accept any information before set-up of the system, unless the information is provided as machine-readable information that may be acquired by the optical image sensor. This implies that the system may only be set-up on site and, therefore, a person setting up the system needs to be physically present on the site at which the system is installed in order to provide the machine-readable information to the optical image sensor.

The set-up of the sensor system establishes a secure communication channel between the processing unit of the sensor system and an external unit, via the communication unit of the sensor system. This ensures that the secure communication channel may only be set up between the sensor system and a specific external unit. The sensor system may further be arranged to only accept future changes to its configuration through the external unit, so that the integrity of the system may be maintained after set-up.

The sensor system may be arranged before set-up to only be able to receive information via said optical image sensor by means of the sensor system actively preventing the communication unit from communicating with external units. For instance, the preventing of the communication unit from communicating may be achieved by the processing unit not activating nor initializing a process that controls the communication unit until a set-up procedure is initiated by machine-readable information being acquired by the optical image sensor.

According to an embodiment, the sensor system establishes wireless communication to the external unit. Thanks to the invention, such wireless communication may be set-up in a secure manner, requiring that a person setting up the system is physically present on the site during set-up. Further, this implies that the cabling needed for the sensor system is minimal.

However, according to an alternative embodiment, the sensor system establishes a wired connection to the external unit. Although a wired connection may not be as easily monitored by unauthorized people, the method according to the invention may still be relevant to use for establishing a wired connection. In a specific embodiment, a wire for establishing communication to an external unit also provides power to the sensor system, such that limited cabling is needed.

According to a second aspect of the invention, there is provided a device for acquiring information relating to a surrounding to the device, said device comprising: an optical image sensor, which is arranged to acquire images of the surrounding to the device; and a processing unit, which is connected to the optical image sensor for receiving acquired images and which is arranged to analyze the acquired images; wherein the processing unit is arranged to only accept information for pre-defined functionalities relating to configuration of the device through the optical image sensor; wherein the optical image sensor is arranged to acquire an image comprising information which is machine-readable and which comprises configuration instructions; and wherein the processing unit is arranged to extract said information from the acquired image, to identify that the extracted information corresponds to configuration instructions, and to trigger a pre-defined functionality of the device using the configuration instructions.

Thanks to the second aspect of the invention, the device may only accept information for pre-defined functionalities relating to configuration of the device through the optical image sensor. This implies that in order to change configuration of the device, the input for changing the configuration needs to be provided on the site where the device is installed. Hence, a person wanting to change the configuration needs to be physically present on the site to provide the machine-readable information to the optical image sensor.

As used herein, the term “processing unit” should be construed as any processor being capable of executing computer instructions. The processing unit may e.g. be implemented as a general-purpose central processing unit, such as a microprocessor, which is provided with specific instruction sets for executing desired computer instructions. The processing unit may alternatively be implemented e.g. as an application-specific integrated circuit (ASIC) or a field-programmable gate array (FPGA) that is specifically designed for the purpose of executing desired computer instructions. The processing unit may be implemented as a single physical entity executing the computer instructions. Alternatively, functions of the processing unit may be divided on a plurality of physical entities, which may be adapted to perform specific parts of the processing or may be arranged to share the computer processing based on a present load on the different entities. Each such entity may be a general-purpose central processing unit or an ASIC or FPGA.

According to an embodiment, the device further comprises a communication unit, and the pre-defined functionalities comprise establishing a secure communication channel between the communication unit and the external unit. This implies that the setting up of the device for establishing a secure communication channel between the device and an external unit may only be triggered by a person being physically present on the site at which the device is installed. The processing unit may be configured to prevent the communication unit from communicating with an external unit before set-up of the sensor system in order to ensure that the secure communication channel may only be triggered by a person on the site.

The pre-defined functionalities may further comprise stopping the optical image sensor from acquiring images. This implies that the optical image sensor may, once installed and properly set up, be arranged to continuously acquire images. Hence, an intruder to a building being monitored by the device may not simply shut off the device in order to avoid being imaged by the device. Rather, the only way to stop the optical image sensor from continuously acquiring images may be to present corresponding machine-readable information to the optical image sensor.

The pre-defined functionalities may further comprise changing configuration for the secure communication channel or resetting the device to factory-default configuration.

According to an embodiment, wherein a secure communication channel is established, the communication unit may be arranged to transmit a data set to an external unit and receive a response comprising a transformation of the data set from the external unit, and the processing unit may be further arranged to check that the data set has been correctly transformed in order to establish the external unit as a trusted part. This implies that it may be ensured that an external unit that is utilized for setting up the sensor system may be trusted and that the established secure communication should be maintained.

For instance, a manufacturer or distributor that distributes sensor systems may provide an encryption key to the external unit, e.g. a mobile phone through which a user wants to control the sensor system. Before the external unit is allowed to be set-up to control the sensor system, it is therefore checked that the external unit may be trusted by means of ensuring that the external unit has received a correct encryption key from the manufacturer or distributor.

According to an embodiment, the sensor system may first identify that the extracted information comprises a configuration for establishing an external unit as a trusted part. In response to such identification, the sensor system may start the procedure to establish that the external unit may be trusted.

According to another embodiment, the sensor system may register the sensor system on a server allowing access to the sensor system via the server. The server may be administered by a manufacturer or distributor of sensor systems, wherein the server provides management of sensor systems. When the sensor system is registered on the server, control of the sensor system is facilitated to a user. The sensor system may further register trusted parts on the server such that a trusted part may configure the sensor system through the server.

According to an embodiment, extracting information from the acquired image comprises analyzing the acquired image in order to detect a code representation in the acquired image. Hence, a processing unit may be arranged to perform image analysis in order to detect any code representation of information in the acquired image. Thus, the machine-readable information may be provided in the form of a code representation.

The extracting of information may further comprise decoding the code representation. Hence, the processing unit may be provided on delivery with a capability of decoding a code representation of information.

The code representation may be a two-dimensional bar code, which is a suitable manner for stably providing a substantial amount of information in an image.

According to another embodiment, the extracted information is encrypted, and the processing unit may further be arranged to decrypt the extracted information using a private key, which is pre-installed in the sensor system. This implies that the machine-readable information which is provided to the optical image sensor needs to be encrypted in order to be accepted by the sensor system. Hence, a third party trying to obtain access or manipulate the system needs to get hold of the key for encrypting information in order to be able to present information to the sensor system that will be accepted.

According to a further embodiment, establishing a secure communication channel comprises exchanging information between the sensor system and the external unit for performing a handshake procedure between the sensor system and the external unit. The sensor system and the external unit may thus exchange information during set-up of the system such that the sensor system and the external unit may thereafter communicate using the secure communication channel. If contact between the sensor system and the external unit is lost, e.g. by the external unit not being within a range of the communication unit of the sensor system, the secure communication channel may be automatically established again without any need for user action when the conditions causing the contact to be lost are removed.

According to an embodiment of the first aspect of the invention, the method may further comprise the sensor system receiving an indication that triggers said analyzing of acquired images. This implies that the sensor system does not need to continuously acquire images in order to be able to capture machine-readable information when provided to the sensor system. Rather, an indication may first be received to trigger analyzing of the acquired images when appropriate. This implies that processing power is only used when it is anticipated that machine-readable information may be provided to the optical image sensor.

According to an embodiment, the receiving of the indication comprises detecting an activation switch being activated. Thus, a user may activate an activation switch when set-up instructions are to be provided so as to trigger the processing unit to analyze the acquired images.

According to an embodiment of the second aspect of the invention, the device further comprises an activation switch, and the processing unit is arranged to receive an indication when the activation switch has been activated, and the processing unit is arranged to trigger analyzing of acquired images when receiving the indication.

### BRIEF DESCRIPTION OF DRAWINGS

These and other aspects of the present invention will now be described in further detail, with reference to the appended drawings showing embodiment(s) of the invention.

FIG. 1 is a schematic view of a sensor system according to an embodiment of the invention.

FIG. 2 is a schematic view of a network to which the sensor system is connected.

FIG. 3 is a flow chart describing a method according to an embodiment of the invention for extracting information from an image in order to set up the sensor system.

FIG. 4 is a flow chart describing a method according to an embodiment of the invention for establishing wireless connection between the sensor system and an external unit.

FIG. 5 is a flow chart describing a method for discovery of devices for establishing connection.

FIG. 6 is a flow chart describing a method for establishing an external unit as a trusted part.

FIG. 7 is a schematic view of processing modules in the sensor system.

FIG. 8 is a flow chart of a method for creating a code representation for providing input to the sensor system.

FIG. 9 is a schematic view of an interface for creating the code representation.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

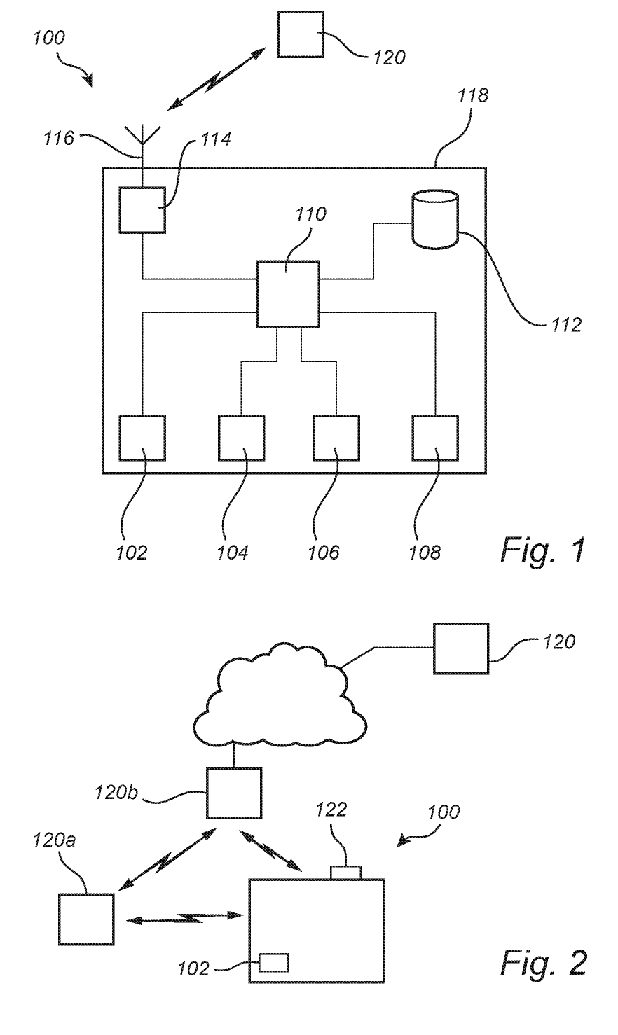

Referring now to FIG. 1, a sensor system 100 according to an embodiment will be described. The sensor system 100 may comprise a plurality of sensors, which may detect and acquire information of the surroundings in which the sensor system 100 is arranged. The plurality of sensors may include an optical image sensor 102, a microphone 104, a position sensor 106 for determining a position of the sensor system 100, and an accelerometer 108 for detecting a movement of the sensor system 100. However, the sensor system 100 may be arranged without several of the plurality of sensors described above. For instance, in a specific embodiment, the sensor system 100 only comprises the optical image sensor 102. Also, other types of sensors may be included in the sensor system 100.

The sensor system 100 may further comprise a processing unit 110, which is connected to the sensors 102, 104, 106, 108 for receiving data acquired by the sensors. The processing unit 110 may be implemented as a general-purpose central processing unit, such as a microprocessor, which is provided with specific instruction sets for executing processes on the sensor system 100. The processing unit 110 may alternatively be implemented as an application-specific integrated circuit (ASIC) or a field-programmable gate array (FPGA) that is specifically designed for the purpose of executing processes on the sensor system 100. The processing unit 110 may have an internal memory, such as a random access memory (RAM), for storing instructions and data necessary for executing processes in the processing unit 110. The processing unit 110 may further be connected to a memory storage 112, such as a flash memory or an electrically erasable programmable read-only memory (EEPROM), which may store applications and data, such that the processing unit 110 may access the applications and data when needed. When an application or process is to be executed by the processing unit 110, instruction sets may be retrieved from the memory storage 112 into the internal memory of the processing unit 110 for allowing quick access of the processing unit 110 to the instruction sets.

The sensor system 100 may further comprise a communication unit 114 for providing communication between the sensor system 100 and external units. The communication unit 114 may comprise an antenna 116 for transmitting and receiving information wirelessly to and from an external unit 120. The communication unit 114 may further comprise a communication controller for converting information into signals to be transmitted by the antenna 116 and for converting signals captured by the antenna 116 into received information. The communication controller may e.g. be implemented as a process in the processing unit 110 or as a processor on a circuit board or an integrated circuit in which the antenna 116 is arranged.

The communication unit 114 may be arranged to communicate with external units 120 via WiFi. Hence, the communication unit 114 may be arranged to communicate using radio waves of e.g. 2.4 or 5 GHz and meeting the Institute of Electrical and Electronics Engineers' (IEEE) 802.11 standards. This may be especially suitable for allowing the communication unit 114 to connect the sensor system 100 to a wireless local area network (WLAN) or a wireless router for providing an access point of the sensor system 100 to a computer network, such as the Internet.

However, the communication unit 114 may alternatively or additionally be arranged to communicate by means of a different communication protocol and/or frequency range. For instance, the communication unit 114 may communicate via Bluetooth®, Zigbee®, or any other suitable communication protocol using radio waves.

According to a further alternative, the sensor system 100 may be connected to an external unit via a wired connection. In a particular embodiment, the wired connection may both provide power to the sensor system 100 and a communication channel for communication between the sensor system 100 and an external unit. For instance, a Power over Ethernet system may be used. This implies that a single cable may be used to provide both data connection and electrical power to the sensor system 100.

The optical image sensor 102 may be arranged to acquire images of a surrounding in which the sensor system 100 is mounted. The sensor system 100 may in this regard comprise lens packages and further optical components (not shown) in order to guide electromagnetic radiation towards the optical image sensor 102. Electromagnetic radiation from a field of view will thus be lead towards the optical image sensor 102, such that an image of the field of view may be acquired. Optionally, the sensor system 100 may comprise a light source for selectively illuminating the field of view in order to improve quality of the acquired images.

The optical image sensor 102 may be arranged to detect the electromagnetic radiation incident on an array of detectors and convert the intensity of electromagnetic radiation to electrical signals by means of e.g. a charge couple device (CCD) sensor or a complementary metal-oxide-semiconductor (CMOS) sensor. By means of the electrical signal from the array of detectors, a digital representation of an image may be acquired.

The optical image sensor 102 may be built into an integrated circuit and/or arranged on a special-purpose circuit board. The processing unit 110 may provide processing capacity in a central processing unit and a processor built-in or directly connected to the optical image sensor 102, hereinafter called an image processor. The optical image sensor 102 may be arranged to transmit the acquired images to the processing unit 110, either to a central processing unit of the sensor system 100 or to the image processor. The image processor may be specifically adapted to perform image processing and image analysis. The image processor may be arranged on the same circuit board or even be integrated with the array of detectors of the optical image sensor 102.

The optical image sensor 102 may be arranged on a specific circuit board within the sensor system 100. Alternatively, the sensor system 100 may be provided with a printed circuit board on which both the processing unit 110 and the optical image sensor 102 are mounted.

The image processor may perform image processing on the acquired images before images are transmitted to a central processing unit of the sensor system 100. Hence, the image processor may be specifically adapted to perform pre-defined image processing operations on the acquired images in order to pre-process the acquired images before being transmitted to the central processing unit. In one embodiment, the image processor may be arranged to perform image processing and image analysis in order to extract information from the acquired images. In such instance, the image processor may be arranged to transmit extracted information to the central processing unit, such that no images are transmitted to the central processing unit.

The sensor system 100 may comprise a housing 118 in which the sensors 102, 104, 106, 108, the processing unit 110, and the communication unit 114 are arranged. The housing 118 is configured for being firmly mounted on a site at which the sensor system 100 is to be installed. Hence, the sensor system 100 may provide a single package, which may be easily installed on a site by mounting the housing 118 to an appropriate structure on the site. For instance, the housing 118 may comprise a flange allowing the flange to be fixed to the appropriate structure on the site.

The housing 118 may be mounted such that the optical image sensor 102 is directed towards a field of view of interest on the site. Hence, the optical image sensor 102 will acquire images of the field of view of interest. The sensor system 100 may be provided with an electric motor for moving the entire housing 118 in the mounting of the housing 118 in order to change the field of view of the optical image sensor 102. Alternatively or additionally, the sensor system 100 may comprise a controller for directing the lens package and/or changing the optical settings of the lens package in order to change the field of view of the optical image sensor 102.

The sensor system 100 may in some embodiments be mounted to a movable object. For instance, the sensor system 100 may be mounted on a vehicle, such as a bus, e.g. for monitoring an entry or exit of the bus. The position sensor 106 and the accelerometer 108 may be useful when the sensor system 100 is mounted to a movable object for acquiring data of the movement of the object.

In another embodiment, the sensor system 100 is mounted to a stationary object. In such an embodiment, the position sensor 106 and/or the accelerometer 108 may be used to provide a warning that the sensor system 100 is improperly being moved. Alternatively, the position sensor 106 and the accelerometer 108 may be omitted.

Referring now to FIG. 2, the communication of the sensor system 100 with external units 120 will be described. The communication may be closely controlled in order to restrict unauthorized access or manipulation of the sensor system 100.

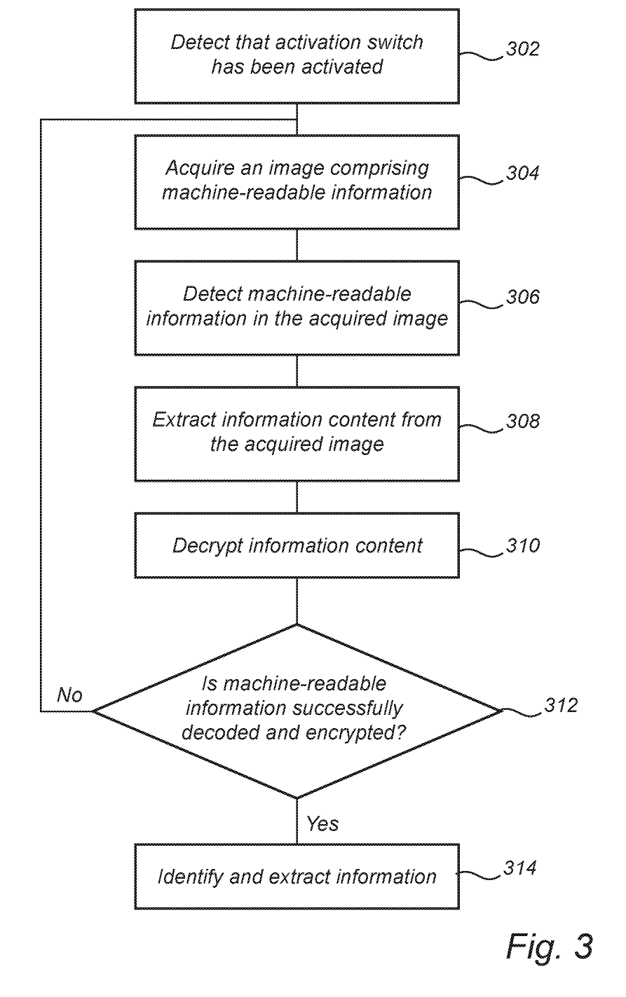

In one embodiment, the sensor system 100 may be arranged with no sockets for wire connections such that the sensor system 100 may only communicate wirelessly. Further, before the sensor system 100 has been set-up, the sensor system 100 may be arranged to only receive information via the optical image sensor 102, as will be further described below with reference to FIG. 3.

In another embodiment, the sensor system 100 may only be provided with a single socket for receiving a cable, such that a single cable may provide both communication between the sensor system 100 and an external unit and electrical power to the sensor system 100.

In yet another embodiment, the sensor system 100 is provided with a wired connection for providing communication between the sensor system 100 and an external unit. Further, the sensor system 100 may be provided with a cable for connecting the sensor system 100 to a power source for powering the sensor system 100.

The sensor system 100 may comprise an activation switch, such as a button 122, for triggering the sensor system 100 to analyze images acquired by the optical image sensor 102 in order to use information in the acquired images for setting up the sensor system 100.

In set-up or installation of the sensor system 100, the sensor system 100 may be configured to communicate with one or more specific external units 120. The set-up may be arranged to form a secure communication channel between the sensor system 100 and the external unit 120.

The set-up may define a specific external unit 120 as a controlling unit 120a for the sensor system 100. The controlling unit 120a may e.g. be a mobile phone, a tablet PC or a personal computer. The controlling unit 120a may run an application allowing a user to provide configuration settings to the sensor system 100. Such configuration settings may be identification information of the sensor system 100, such that an application receiving data from the sensor system 100 may determine its origin, input for controlling a field of view of the optical image sensor 102 and optical settings for acquiring of images, and settings regarding communication with external units 120. The controlling unit 120a may also reset the sensor system 100 or reset the configuration to factory settings. The sensor system 100 may be arranged to only accept and act on received configuration settings from the controlling unit 120a.

The controlling unit 120a may also download applications that are to be run by the processing unit 110 of the sensor system 100. The sensor system 100 may be further arranged to only accept and install or update applications that are received from the controlling unit 120.

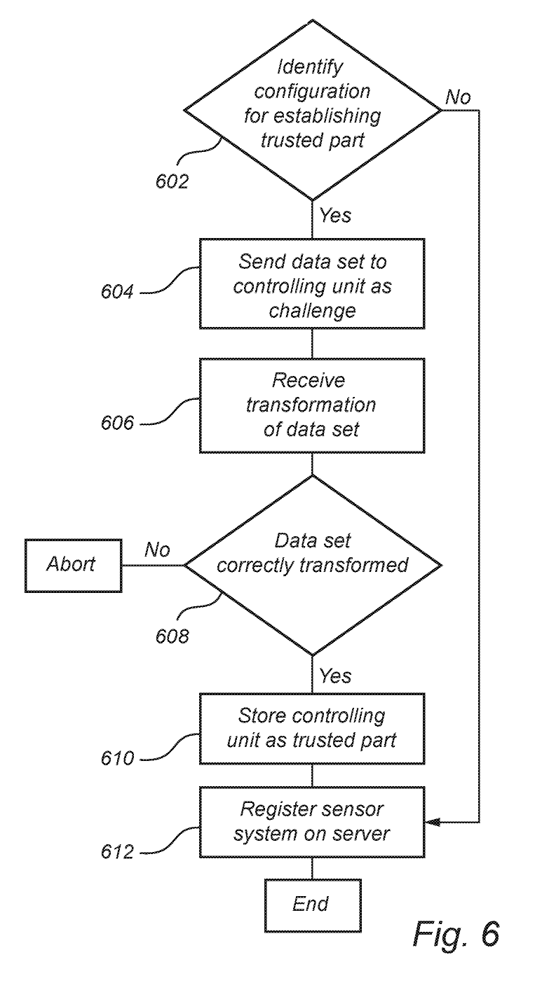

By means of the sensor system 100 only accepting certain information, such as configuration settings and applications, from the controlling unit 120a, manipulation of the sensor system 100 by an unauthorized party is prevented. The controlling unit 120a may be established as a trusted part by the sensor system 100, as will be further explained below with reference to FIG. 6.

The set-up may also define a specific external unit 120 as a communication point 120b. The communication point 120b may e.g. be a router for allowing the sensor system 100 access to a computer network via the router. Alternatively, the communication point 120b may be a server or a computer on a wireless local area network (WLAN), such that information transmitted by the sensor system 100 may be handled within the WLAN or, optionally, further transmitted to another computer network. As a further alternative, the communication point 120b may be a server on a computer network, which the sensor system 100 is connected to through a wired connection.

In one embodiment, the sensor system 100 may be set up only to communicate with one external unit 120, which may then constitute both the controlling unit 120a and the communication point 120b.

The sensor system 100 may communicate acquired information to the communication point 120b and/or the controlling unit 120a. The acquired information may be further transmitted to an application that uses the acquired information as data input, such as a surveillance application for monitoring an area of interest being viewed by the optical image sensor 102. The application receiving the acquired information may be run on the communication point 120b or the controlling unit 120a or on another external unit 120, which may receive the acquired information via the communication point 120b.

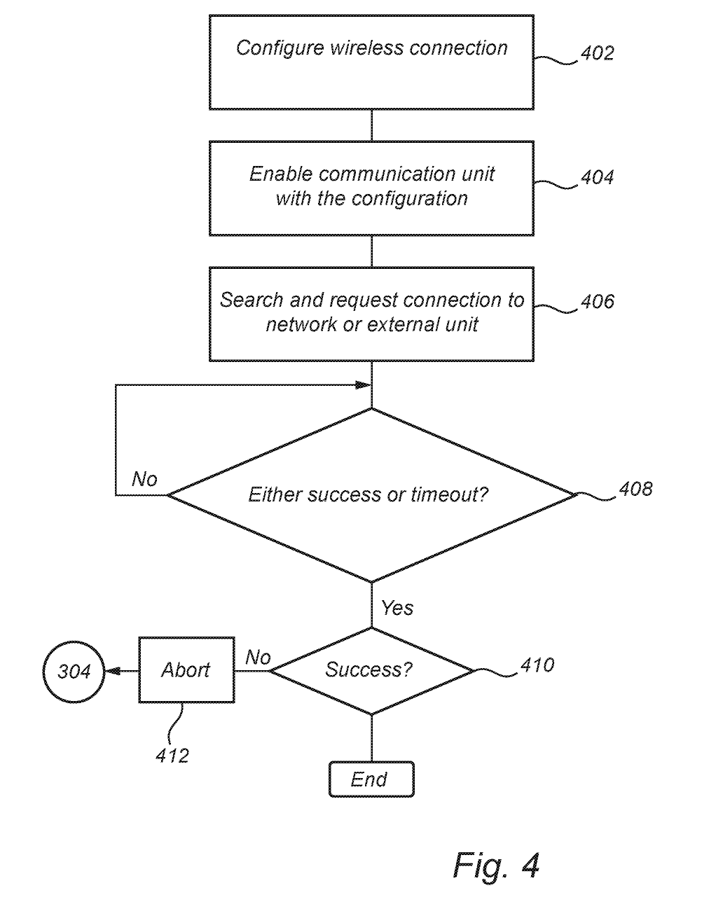

Referring now to FIGS. 3-4, a method of setting up the sensor system 100 will be described. Before the set up of the sensor system 100, the communication unit 114 may be prevented from communicating with external units 120. Hence, it is only through input of information via the optical image sensor 102 that the communication with external units 120 may be set-up. In particular, the communication unit 114 may not be set up by receiving requests or information for setting up communication through an interface of the communication unit 114.

The communication unit 114 may be prevented from communicating with external units 120 by means of a process for controlling the communication unit 114 not being active.

The method may be initiated by the sensor system 100 detecting that an activation switch 122 on the sensor system 100 is activated, step 302. Activation of the activation switch 122 triggers the sensor system 100 to start a set-up process. This implies that the sensor system 100 need not be continuously analyzing whether input to the set-up process is provided. Rather, such analysis only starts when the activation switch 122 is activated, whereby processing power used by the sensor system 100 is limited.

However, the sensor system 100 may alternatively be arranged to always analyze whether input to the set-up process is provided. In such case, the sensor system 100 may not need to be provided with an activation switch 122.

Input for setting up the sensor system 100 may only be provided through the optical image sensor 102. The activation of the activation switch 122 may trigger the optical image sensor 102 to start acquiring images. Alternatively, the optical image sensor 102 may be arranged to continuously acquire images. In such case, the activation of the activation switch 122 may trigger the processing unit 110 to start executing an image analysis process for identifying input for setting up the sensor system 100.

The optical image sensor 102 will acquire an image comprising machine-readable information, step 304. The machine-readable information comprises set-up instructions which may be used by the sensor system 100 for setting up the sensor system 100.

The machine-readable information is thus presented to the sensor system 100 in such a way that an image comprising machine-readable information is acquired. This may be accomplished by a user, such as an installer of the sensor system 100, arranging machine-readable information in the field of view of the optical image sensor 102.

The machine-readable information may be provided in any form such that the machine-readable information may be imaged and interpreted through image analysis. In one embodiment, the machine-readable information may be provided as text that may be recognized using optical character recognition (OCR). In another embodiment, the machine-readable information is provided as a code representation of the information. The code representation may be a one-dimensional or two-dimensional bar code. Alternatively, the machine-readable information may be provided as a combination of text and a code representation. In such case, the code representation may e.g. provide encryption information, whereas the text may provide settings information. However, other distributions of the representation of information may be contemplated.

In one embodiment, the machine-readable information may be provided as a Quick Response (QR) code, which is a common type of two-dimensional bar code. The QR code provides indications of corners of the two-dimensional bar code, such that information content in the QR code may be easily extracted from an acquired image of the QR code.

The machine-readable information may be presented to the optical image sensor by a user holding an object, which is provided with the machine-readable information in front of the optical image sensor 102. Hence, the machine-readable information may be printed on a card or a piece of paper, which is held in front of the optical image sensor 102. In another embodiment, the machine-readable information is presented on a display, such as a display of a mobile phone, a portable computer, or a screen connected to a computer, and the display is arranged or held in front of the optical image sensor 102.

The acquired image is transmitted to an image analysis process, which may be run by the image processor of the optical image sensor 102 or by the central processing unit or partly on both units. In the image analysis process, the machine-readable information is detected in the acquired image, step 306, and the information content of the machine-readable information is extracted from the acquired image, step 308. The extraction of the information content may comprise identifying an area of the acquired image in which the machine-readable information is imaged and converting the machine-readable information to a digital representation of the information content. The converting of the machine-readable information may comprise decoding the machine-readable information, if the machine-readable information is presented as a code representation.

The information content of the machine-readable information may be encrypted. In an embodiment, the sensor system 100 is provided with a private encryption key during manufacture or preparation of the sensor system 100 before the sensor system 100 is delivered to a customer. Hence, after the information content of the machine-readable information has been extracted, the information content may be decrypted using the private encryption key, step 310.

The image analysis process checks, step 312, whether the machine-readable information was successfully decoded and encrypted from the acquired image. If not, the process ends and returns to the image acquisition step 304 for acquiring a new image. A check whether it will be possible to obtain the machine-readable information may be performed after a plurality of steps or after each step in the image analysis process, so that the process may be restarted from the image acquisition step 304 as soon as possible.

The information content obtained from the image analysis is then further analyzed in order to identify and extract information, step 314, for forming a connection between the sensor system 100 and an external unit 120.

Referring now to FIG. 4, a process for establishing a wireless connection to an external unit will be described. The extracted information for forming a connection is provided to a process for establishing connection, which may be executed in the processing unit 110. This triggers the communication unit 114 to identify an external unit 120.

The extracted information for forming a wireless connection may comprise wireless connection parameters for establishing a communication channel. The wireless connection may be configured, step 402. This may imply establishing a wireless communication protocol to be used and providing wireless connection parameters to a communication stack. The communication unit 114 is then enabled with the configuration, step 404.

The communication unit 114 may then search for and request connection to one or more networks or external units 120 within a range of wireless communication, step 406. The request to connect to a network or a specific external unit 120 may comprise that the communication unit 114 provides wireless connection parameters in the communication stack, such as a password, a personal identification number (PIN) or other information necessary to establish connection.

The process for establishing wireless connection may then enter a loop, step 408, waiting for either success in establishing wireless connection or a timeout. Exiting the loop means either success or timeout and this status is checked, step 410. If there was a timeout, the process for establishing wireless connection is aborted, step 412, and the process for setting up the sensor system 100 is returned to the image acquisition step 304 for acquiring a new image. The abortion of the process may be signaled to a user so that the user may present the machine-readable information again to the optical image sensor 102.

If the check in step 410 indicates a success, the sensor system 100 may exchange encryption keys with the external unit 120 in order to ensure that the communication channel is secure. Alternatively, the encryption key is provided by the wireless connection parameters and may be used when initiating connection in step 406 and the process for establishing wireless connection may be ended. The set-up of wireless communication between the sensor system 100 and the external unit 120 may constitute a handshaking procedure between the two units such that, if connection between the units is lost the connection may be re-established automatically once the circumstances causing loss of the connection are removed.

The sensor system 100 may be arranged to establish a secure communication channel to a specific external unit, which may act as a controlling unit 120a. The controlling unit 120a may be implemented as a portable unit, such as a mobile phone. The controlling unit 120a and the sensor system 100 may exchange information during set-up such that a wireless communication may be automatically established as soon as the controlling unit 120a is within range of the sensor system 100. The establishing of the controlling unit 120a as a trusted part will be further described below with reference to FIG. 6.

The sensor system 100 may further be arranged to establish a secure communication channel to a communication point 120b providing access to a WLAN and/or another computer network, such as the Internet.

The sensor system 100 may alternatively be arranged to communicate through a wired connection to an external unit. A process for establishing a wired connection to an external unit may be similar to the above-described process for establishing a wireless connection.

The extracted information for forming a connection may comprise connection parameters for establishing a communication channel. The connection may thus be configured, e.g. by establishing a protocol to be used and providing connection parameters to a communication stack, whereby the communication unit is enabled with the configuration.

The communication unit 114 may then search for and request connection to one or more external units 120 that are accessible through the wired connection. The request to connect to an external unit 120 may comprise that the communication unit 114 provides connection parameters in the communication stack, such as a password, a PIN or other information necessary to establish connection.

The process for establishing connection may then enter a loop which is either terminated by a successful connection or a timeout. If the connection is successfully established, encryption keys may be exchanged in order to ensure a secure communication channel. The wired connection may establish a communication channel to a communication point 120b, which may further allow access to the sensor system 100 to a WLAN and/or another computer network, such as the Internet.

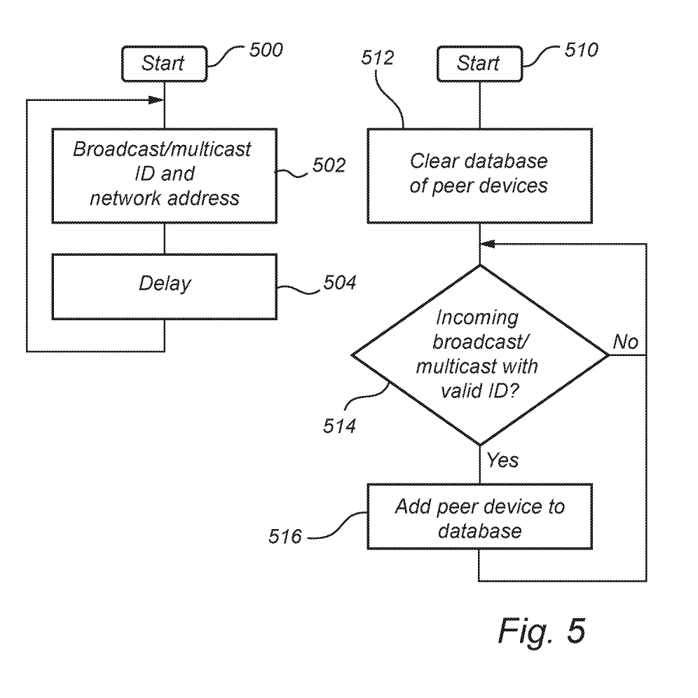

Referring now to FIG. 5, the sensor system 100 may further be set up to communicate on a computer network via the communication point 120b. A process for mutual discovery of devices may be executed in the processing unit 110.

The process is accomplished by two execution threads. A first thread 500 is responsible for providing information to other devices. An identifier and network address of the sensor system 100 is broadcasted/multicasted, step 502, in order for other electronic devices on the network to discover the sensor system 100. After a broadcast/multicast is made, the process waits for a certain period of time, step 504, before performing a new broadcast/multicast, if necessary.

A second thread 510 is responsible for discovery of other devices. First, a database of peer devices is cleared, step 512. Then, incoming broadcasts/multicasts with a proper formatting and on a proper port are detected, step 514. Once a valid incoming message is received, a received identifier and network address of the peer device is added to the database of peer devices, step 516.

The controlling unit 120a may be set up to communicate via the communication point 120b. The communication point 120b may typically be a wireless router such that the installed sensor system 100 may maintain a connection with the communication point 120b at all times. The controlling unit 120a may be a portable unit, which may not always be able to be in direct contact with the sensor system 100. However, the controlling unit 120a may connect to the communication point 120b via a computer network, such as the Internet. Hence, a user may provide input to the sensor system 100 from a remote site via the controlling unit 120a providing information to the sensor system 100 through the communication point 120b. Alternatively, the controlling unit 120a may provide information to the sensor system 100 through a server on which the sensor system 100 registers, as will be further described with reference to FIG. 6.

The sensor system 100 may be able to identify that received information originates from the controlling unit 120a by determining the identifier of the controlling unit 120a. Further, communication may be encrypted using the encryption keys exchanged during set-up such that only information provided with a proper encryption will be accepted by the sensor system 100 for providing configuration settings.

The sensor system 100 may thus after set-up only accept instructions to change configuration settings from the controlling unit 120a. Further, applications for controlling how the sensor system 100 interacts with acquired data from the sensors 102, 104, 106, 108 may only be installed onto the sensor system 100 through the controlling unit 120a. However, when such an application is executed on the sensor system 100, the sensor system 100 may transmit data via the communication point 120b to any external unit 120, such as a server or external receiver for handling application data. Also, the sensor system 100 may receive information from such an external unit 120 for controlling the application that is run on the sensor system 100.

Referring now to FIG. 6, the sensor system 100 may further be set up to establish the controlling unit 120a as a trusted part. By means of ensuring that the controlling unit 120a may be trusted, an external unit 120 may not be allowed to control the sensor system 100 unless the external unit 120 has been provided with information proving that it may be trusted.

Thus, after a communication channel to an external unit 120 has been established, e.g. to a communication point 120b, the processing unit 110 may be arranged to determine whether an external unit 120a is to be established as a trusted part. The processing unit may thus identify, step 602, whether the information content extracted from the acquired image of the machine-readable information comprises a configuration for establishing the controlling unit 120a as a trusted part. If not, the sensor system 100 will not establish an external unit 120 as a trusted part, and may directly proceed to register the sensor system 100 on an external server, as will be further described below.

The configuration for establishing the controlling unit 120a as a trusted part may include an indication of an identity of the controlling unit 120a so that the sensor system 100 may be able to communicate with the controlling unit 120a. For instance, if a communication channel has been set up to a communication point 120b, the sensor system 100 will need to direct messages via the communication point 120b to the controlling unit 120a.

The processing unit 110 of the sensor system 100 will then produce a data set that is to be transmitted to the controlling unit 120a. The data set may be a random number or pattern, or a parameter such as a time stamp. The data set is sent to the controlling unit 120a, step 604, challenging the controlling unit to prove that the controlling unit 120a may be trusted.

The controlling unit 120a is provided with a secret encryption key, which is used for encrypting the data set. The controlling unit 120a may be provided with the secret encryption key from a trusted actor. For instance, a manufacturer or distributor of sensor systems 100 may provide the secret encryption key to a user of the controlling unit 120a upon purchase of the sensor system 100. Further, the sensor system 100 may, during manufacture or when being sold, be provided with an encryption key, corresponding to the secret encryption key received by the controlling unit 120a.

Thus, the controlling unit 120a may use its secret encryption key to transform the data set received from the sensor system 100, The controlling unit 120a may thus send the transformed data set back to the sensor system 100. The sensor system 100 received the transformation of the data set, step 606.

The processing unit 110 may then analyze the transformation of the data set in order to check that the data set has been correctly transformed, step 608. In this regard, the processing unit 110 determines that the data set has been transformed using a secret encryption key that originates from a trusted actor. Thus, if the controlling unit 120a is in possession of the secret encryption key, the controlling unit 120a may also be trusted.

If the check concludes that the controlling unit 120a cannot be trusted, the process is aborted, and the communication channel needs to be set up again by presenting machine-readable information to the optical image sensor 102.

If the check concludes that the controlling unit 120a can be trusted, the processing unit 110 stores, step 610, information about the controlling unit 120a in the memory storage 112 of the sensor system 100 identifying the controlling unit 120a as a trusted part.

The sensor system 100 may then register, step 612, on a server providing identity of the sensor system 100 and information for allowing communication with the sensor system 100. The sensor system 100 may further indicate when registering on the server whether a trusted part has been established and information identifying the trusted part.

The server may be managed by a manufacturer or distributor of the sensor systems 100 or a party affiliated with the manufacturer or distributor. The server may provide an interface for controlling the sensor system 100. Hence, a user may connect to the server using the controlling unit 120a and may then control or configure the sensor system 100 via the server.

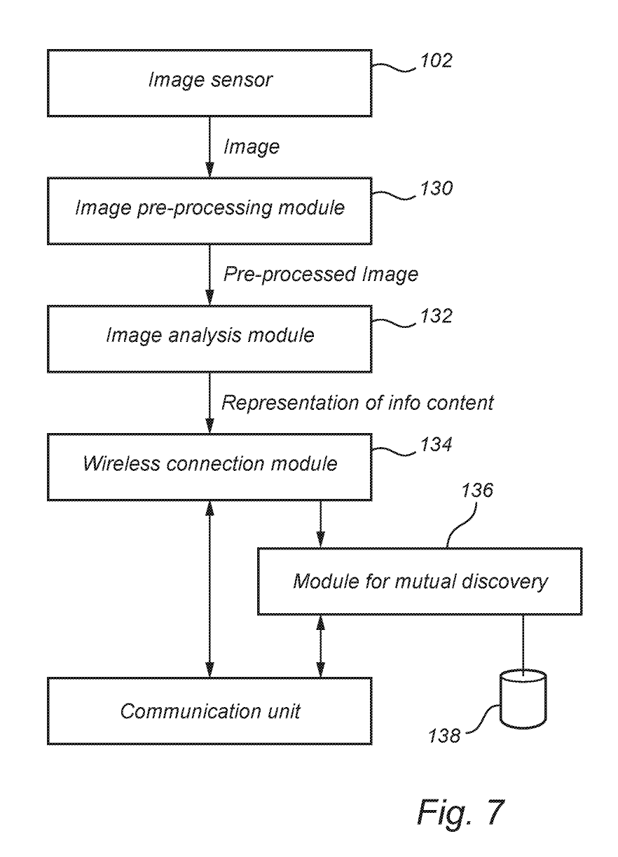

Referring now to FIG. 7, the processing within the sensor system 100 will be further described. As described above, the sensor system 100 comprises a processing unit 110 and may further have processing capacity within further components of the sensor system 100, such as the optical image sensor 102 or the communication unit 114. These components may be arranged on separate circuit boards, connected to a main circuit board on which the processing unit 110 is mounted, or may be arranged as specific integrated circuits on the main circuit board.

The execution of processes in the sensor system 100 may be shared or distributed between the different components in a number of different manners as will be realized by a person skilled in the art. Below, the processing that occurs within the sensor system 100 will be described as modules, and it will therefore be realized that these modules may be implemented in any of the components of the sensor system 100.

The sensor system 100 may comprise an image pre-processing module 130. The image pre-processing module 130 may receive an acquired image from the image sensor 102. The image pre-processing module 130 may process the image in order to improve a quality of the image, such as filtering the image to remove noise, blurring or artifacts, such as reflexes in the image. The image pre-processing module 130 may output the pre-processed image to an image analysis module 132.

The image analysis module 132 may be arranged to detect specific features in the image in order to detect machine-readable information. For instance, a code representation, such as a QR code, may comprise distinct features for indicating boundaries of the code representation. Hence, the image analysis module 132 may be arranged to detect such features in an image and determine an area in the image that holds the machine-readable information. The image analysis module 132 may further be arranged to extract the machine-readable information and convert the machine-readable information to a digital representation of the information content, e.g. by decoding a code representation in the image. The image analysis module 132 may hence extract a digital representation of the information content in the image and output this digital representation to a connection module 134.

The connection module 134 receives the digital representation and interprets the digital representation as instructions and parameters for establishing connection to an external unit. The connection module 134 controls the communication unit 114 to establish connection with an external unit 120 on a network.

Once the connection is established, a module for mutual discovery 136 having a database 138 of peer devices may establish a relation to peer devices and store identifiers and network addresses of the peer devices in the database 138.

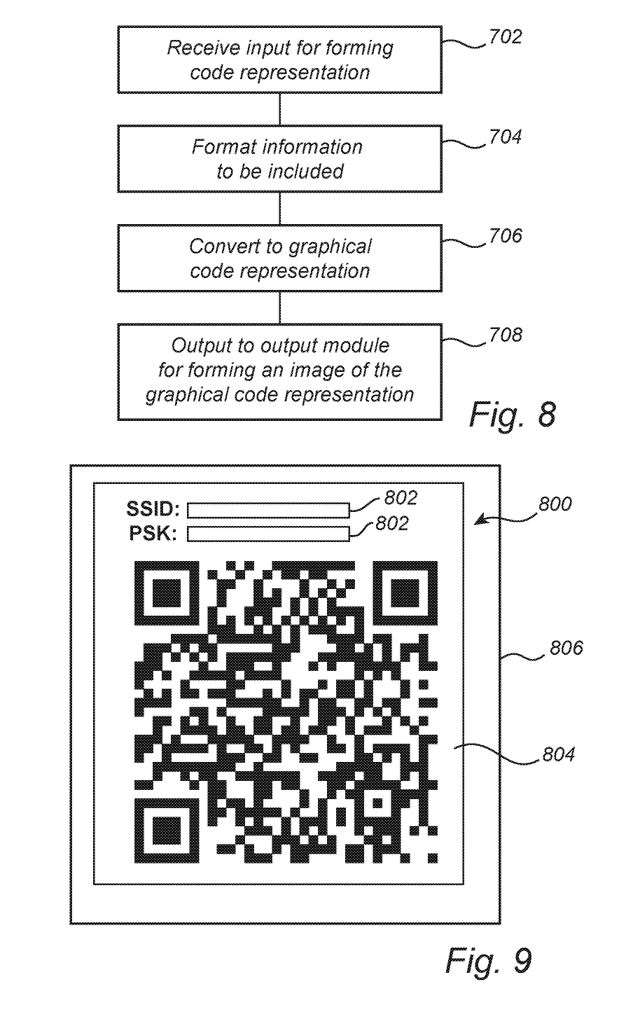

Referring now to FIG. 8, a method of creating a code representation of machine-readable information that is to be presented to the optical image sensor 102 is described. The method may be executed in a computer unit, such as a mobile phone, a tablet PC, or a personal computer. The computer unit may run a code creation module for creating the code representation.

The code creation module may receive input for forming the code representation, step 702. This input may comprise information for setting up a connection, such as instructions and the connection parameters needed by the sensor system 100 for establishing connection. The instructions and connection parameters may be received from a node in a network to which connection is to be set up, or may be provided by a user or installer when the code representation is to be formed.

The input may further comprise an encryption key to be used for encrypting the information into the code representation. The encryption key corresponds to the private encryption key, which is pre-installed in the sensor system 100. The encryption key may be provided to a customer on purchase of the sensor system 100. Alternatively, an installer of the sensor system 100, which may have a relation to a manufacturer of the sensor system 100, may possess the encryption key.

The code creation module then formats the information to be included in the code representation, step 704. In this regard, the information is arranged in a sequence so that it will be properly interpreted by the sensor system 100. Further, the information is encrypted using the encryption key.

The formatted information is converted to a graphical code representation, step 706. Hence, the formatted information is decoded according to the desired code representation, such as a QR code.

The code creation module may thus output the graphical code representation to an output module for forming an image of the graphical code representation, step 708. The output module may be a display or screen of the computer unit, which may present an image of the graphical code representation. The output module may alternatively be a printer for printing the image of the graphical code representation onto a substrate, such as a piece of paper.

In a specific embodiment, as illustrated in FIG. 9, a computer unit may provide a user interface 800 for entering connection parameters. A user may be prompted to input connection parameters into defined fields 802, such as a service set identifier (SSID) providing a password for a device to connect to a WLAN and a pre-shared key (PSK) to be used in encryption of the communication. When a user has entered these connection parameters, the code representation may be formed and output. As shown in FIG. 9, a QR code 804 may be output to a display 806 on which the user interface 800 is provided, such as a display 806 of a mobile phone. The display 806 may then be held in front of the optical image sensor 102, such that an image of the QR code 804 may be acquired. Alternatively, the QR code 804 may be printed onto a piece of paper, which may then be held in front of the optical image sensor 102.

According to an alternative embodiment, the machine-readable information may be delivered as a pre-printed card or piece of paper upon purchase of the sensor system 100. The pre-printed card may thus provide pre-set information of connection parameters to the sensor system 100, when the machine-readable information is presented to the optical image sensor 102. Hence, the connection parameters may not be set in dependence of the external units 120 to which the sensor system 100 is to be connected. Thus, upon set-up of the sensor system 100, the user or installer of the sensor system 100 may first need to adapt the connection parameters of the external unit 120 to fit the parameters being used by the sensor system 100. Alternatively, a user may provide information of the connection parameters to a manufacturer or distributor of the sensor system 100 when making an order for the sensor system 100. These connection parameters may thus be used by the manufacturer or distributor for providing pre-printed cards carrying the machine-readable information.

The sensor system 100 may be further arranged to only accept information for pre-defined functionalities relating to configuration of the sensor system 100 through the optical image sensor 102. Hence, even after set-up of the sensor system 100, some pre-defined functionalities may only be triggered through the optical image sensor 102. This implies that even if an unauthorized party is able to connect to the sensor system 100 through the communication unit 114, the unauthorized party may not trigger the pre-defined functionalities.

The pre-defined functionalities may include stopping one or more of the sensors 102, 104, 106, 108 from acquiring data. Hence, the optical image sensor 102 may be arranged, once the sensor system 100 is set up, to continuously acquire images of a field of view. The only way of stopping the optical image sensor 102, or any other sensor 104, 106, 108, from acquiring data may be to present a machine-readable instruction to the optical image sensor 102.

The pre-defined functionalities may further include changing configuration for the secure communication channel. For instance, if a user buys a new mobile phone, the configuration of the sensor system 100 is to be changed so as to register the new mobile phone as the controlling unit 120a. Also, the pre-defined functionalities may further include resetting the sensor system 100 to factory-default configuration.

Pre-printed cards provided with machine-readable information for triggering the pre-defined functionalities may be provided when the sensor system 100 is purchased. However, the machine-readable information for initiating a pre-defined functionality may alternatively be created in a similar manner as explained with reference to FIG. 8 for creating a code representation for setting up the sensor system 100.

The person skilled in the art realizes that the present invention by no means is limited to the preferred embodiments described above. On the contrary, many modifications and variations are possible within the scope of the appended claims.

1-18. (canceled)

19. A method for setting up a sensor system comprising an optical image sensor, a processing unit and a communication unit, the method comprising:
preventing the communication unit from communicating with an external unit before set-up of the sensor system;
acquiring an image via the optical image sensor, the image comprising machine-readable information, the machine-readable information comprising set-up instructions;
extracting the machine-readable information from the acquired image via the processing unit;
determining that the machine-readable information comprises the set-up instructions;
triggering the communication unit to identify the external unit in a computer network; and
establishing a secure communication channel between the communication unit and the external unit using the set-up instructions.

20. The method according to claim 19, further comprising determining that the machine-readable information comprises a configuration for establishing the external unit as a trusted part.

21. The method according to claim 20, wherein establishing the external unit as a trusted part comprises:
sending a data set to the external unit;
receiving a response comprising a transformation of the data set from the external unit; and
verifying that the data set has been correctly transformed.

22. The method according to claim 19, further comprising:
registering the sensor system on a server; and
allowing access to the sensor system via the server.

23. The method according to claim 19, wherein extracting the machine-readable information from the acquired image comprises analyzing the acquired image in order to detect a code representation in the acquired image.

24. The method according to claim 23, wherein extracting the machine-readable information from the acquired image further comprises decoding the code representation.

25. The method according to claim 23, wherein the code representation is a two-dimensional bar code.

26. The method according to claim 23, further comprising the sensor system receiving an indication that triggers the analyzing of the acquired image.

27. The method according to claim 26, wherein receiving the indication comprises detecting that an activation switch has been activated.

28. The method according to claim 19, wherein the machine-readable information is encrypted, and the method further comprises decrypting the machine-readable information using a private key pre-installed in the sensor system.

29. The method according to claim 19, wherein establishing the secure communication channel comprises exchanging information between the sensor system and the external unit for performing a handshake procedure between the sensor system and the external unit.

30. A device comprising:
an optical image sensor configured to acquire an image comprising machine-readable information, the machine-readable information comprising configuration instructions for the device; and
a processing unit connected to the optical image sensor and configured to only accept information for pre-defined functionalities relating to a configuration of the device through the optical image sensor, the processing unit further configured to receive the image acquired by the optical image sensor and analyze the acquired image, wherein the analyzing of the acquired image comprises:
extracting the machine-readable information from the acquired image;
determining that the machine-readable information comprises the configuration instructions; and
triggering one or more of the pre-defined functionalities of the device using the configuration instructions.

31. The device according to claim 30, wherein the device further comprises a communication unit, wherein the processing unit is configured to prevent the communication unit from communicating with an external unit before set-up of the device, and wherein the pre-defined functionalities comprise establishing a secure communication channel between the communication unit and the external unit.

32. The device according to claim 31, wherein the communication unit is configured to transmit a data set to the external unit and receive a response comprising a transformation of the data set from the external unit, and the processing unit is further configured to verify that the data set has been correctly transformed in order to establish the external unit as a trusted part.

33. The device according to claim 30, wherein the analyzing of the acquired image further comprises detecting a code representation in the acquired image.

34. The device according to claim 33, wherein the analyzing of the acquired image further comprises decoding the code representation.

35. The device according to claim 30, further comprising an activation switch, wherein the processing unit is configured to receive an indication when the activation switch has been activated, and trigger the analyzing of the acquired image in response to receiving the indication.

36. The device according to claim 30, wherein the machine-readable information is encrypted, and wherein the analyzing of the acquired image further comprises decrypting the machine-readable information using a private key pre-installed in the device.
